(19) United States
(12) Patent Application Publication
(10) Pub. No.: US 2003/0138567 A1
(43) Pub. Date: Jul. 24, 2003

(54) Anti-corrosive agents and method for protecting metal surfaces against corrosion

(76) Inventors: Bernd Schenzle, Heidelberg (DE); Alina M Koch, Duesseldorf (DE)

Correspondence Address: HENKEL CORPORATION, 2500 RENAISSANCE BLVD, STE 200, GULPH MILLS, PA, 19406, US

(21) Appl. No.: 10/203,150

(22) PCT Filed: Jan. 27, 2001
(86) PCT No.: PCT/EP01/00885

(30) Foreign Application Priority Data
Feb. 7, 2000 (DE) 100 05 113.8

(51) Int. Cl. B05D 3/02

(52) U.S. Cl. 427/388.1

(57) ABSTRACT

The invention relates to a method for providing a metal surface with an anti-corrosion treatment. Said method is characterized in that the metal surface is brought into contact with a homo- or copolymer of vinylpyrrolidone. The invention also relates to a solution for application, containing a) 0.02 to 20 g/l phosphoric acid and/or at least one fluoro acid of one or more elements of the following group: Zr, Ti, Hf and Si; or their respective anions and b) 0.05 to 20 g/l of a homo or copolymer of vinylpyrrolidone; and to a concentrate for the same.

This invention relates to the field of corrosion protection treatment of metal surfaces. One aspect of the present invention involves depositing an anticorrosive layer onto the bare metal surface. A second aspect of the present invention involves enhancing the anticorrosive action of an anticorrosive layer already deposited onto the metal surface. A particular feature of the present invention is that no toxic heavy metals, such as chromium or nickel, have to be used.

There is extensive prior art relating to the deposition of anticorrosive layers onto bare metal surfaces and to the rinsing of already coated metal surfaces in order to increase corrosion protection. Some examples of documents which deal in particular with the chromium-free treatment of aluminum surfaces are given below. The term “conversion treatment” used in this connection indicates that components of the treatment solution react chemically with the metal surface, resulting in the formation of an anticorrosive layer into which both components of the treatment solution and metal atoms from the metal surface are incorporated.

The chromium-free conversion treatment of aluminum surfaces with fluorides of boron, silicon, titanium or zirconium, alone or in combination with organic polymers, in order to achieve a permanent corrosion protection and to produce a foundation for a subsequent coating is in principle known.

U.S. Pat. No. 5,129,967 discloses treatment baths for a no-rinse treatment (therein referred to as “dried in place conversion coating”) of aluminum, containing:

(a) 10 to 16 g/l polyacrylic acid or homopolymers thereof,

(b) 12 to 19 g/l hexafluorozirconic acid,

(c) 0.17 to 0.3 g/l hydrofluoric acid, and

(d) up to 0.6 g/l hexafluorotitanic acid.

EP-B-8 942 discloses treatment solutions, preferably for aluminum cans, containing:

(a) 0.5 to 10 g/l polyacrylic acid or an ester thereof, and

(b) 0.2 to 8 g/l of at least one of the compounds H₂ZrF₆, H₂TiF₆ and H₂SiF₆, wherein the pH of the solution is below 3.5,

as well as an aqueous concentrate for replenishing the treatment solution, containing:

(a) 25 to 100 g/l polyacrylic acid or an ester thereof,

(b) 25 to 100 g/l of at least one of the compounds H₂ZrF₆, H₂TiF₆ and H₂SiF₆, and

(c) a source of free fluoride ions which provides 17 to 120 g/l free fluoride.

DE-C-19 33 013 discloses treatment baths having a pH of above 3.5 which, besides complex fluorides of boron, titanium or zirconium in quantities of 0.1 to 15 g/l, based on the metals, contain in addition 0.5 to 30 g/l oxidising agent, in particular sodium metanitrobenzenesulfonate.

DE-C-24 33 704 describes treatment baths for increasing the coating adhesion and the permanent corrosion protection on, inter alia, aluminum; these baths may contain 0.1 to 5 g/l polyacrylic acid or salts or esters thereof, as well as 0.1 to 3.5 g/i ammonium fluorozirconate, calculated as ZrO₂. The pH of these baths may vary over a wide range. The best results are generally obtained when the pH is from 6 to 8.

U.S. Pat. No. 4,992,116 describes treatment baths for the conversion treatment of aluminum having a pH of between about 2.5 and 5, which contain at least three components:

(a) phosphate ions within the concentration range of between 1.1×10⁻⁵ and 5.3×10⁻³ mol/l, corresponding to 1 to 500 mg/l,

(b) 1.1×10⁻⁵ to 1.3×10⁻³ mol/l of a fluoric acid of an element selected from Zr, Ti, Hf and Si (corresponding to 1.6 to 380 mg/l, depending on the element), and

(c) 0.26 to 20 g/l of a polyphenol compound, obtainable by the reaction of poly(vinylphenol) with aldehydes and organic amines.

Here, a molar ratio of fluoric acid to phosphate of about 2.5:1 up to 1:10 is to be maintained.

DE-A-27 15 292 discloses treatment baths for the chromium-free preliminary treatment of aluminum cans. These baths contain at least 10 ppm titanium and/or zirconium, between 10 and 1000 ppm phosphate and a quantity of fluoride sufficient for the formation of complex fluorides of the titanium and/or zirconium present, but at least 13 ppm, and have a pH of between 1.5 and 4.

WO 92/07973 discloses a chromium-free treatment process for aluminum which uses from 0.01 to about 18 wt. % H₂ZrF₆ and from 0.01 to about 10 wt. % of a 3-(N-C₁-C₄-alkyl-N-2-hydroxyethylaminomethyl)-4-hydroxystyrene polymer as essential components in acidic aqueous solution. Optional components are 0.05 to 10 wt. % dispersed SiO₂, 0.06 to 0.6 wt. % of a solubilizer for the polymer, as well as a surfactant.

Notwithstanding this extensive prior art, of which only extracts are reported here, there is still a need for improved agents and processes for the corrosion protection treatment of metal surfaces. An object of the present invention is to provide new agents and processes for this purpose, in order to extend the range of available agents and processes for corrosion protection.

The present invention is based on the finding that homo- or co-polymers of vinylpyrrolidone exhibit an excellent anticorrosive action. In a first aspect, the present invention relates to a process for the corrosion protection treatment of a metal surface, which is characterised in that the metal surface is contacted with a homo- or co-polymer of vinylpyrrolidone. Here, in a first embodiment of the present invention, the metal surface may initially be subjected to a conversion treatment according to the prior art, for example, a phosphating using zinc or iron, a conversion treatment using fluoric acids of metals, for example titanium, zirconium or hafnium, or even boron or silicon, or a treatment using a solution or suspension of an organic polymer which contains no vinylpyrrolidone units. Examples of such polymers are given in the literature cited in the introduction.

A particular embodiment of the process of contacting the metal surface, which is either bare or already has a conventional conversion layer, with a homo- or co-polymer of vinylpyrrolidone, involves applying to this metal surface a coating which contains a homo- or co-polymer of vinylpyrrolidone. The anticorrosive action of the coating is improved by the presence of the homo- or co-polymer of vinylpyrrolidone.

An alternative embodiment of the present invention involves contacting the metal surface with a homo- or co-polymer of vinylpyrrolidone at the same time that the metal surface is being subjected to a conversion treatment. In this case, the homo- or co-polymer is therefore present in the treatment solution by means of which a conversion layer is produced on the metal surface. The treatment solution for the production of the conversion layer may contain, for example, phosphoric acid or anions thereof. Divalent cations, such as zinc and/or manganese may also be present in the treatment solution. A particular example of such a treatment solution for the production of a conversion layer is a zinc phosphating solution, which produces a crystalline layer of zinc-containing metal phosphates on the metal surface. The treatment solution may, however, also contain phosphoric acid and/or anions thereof, but no divalent metals.

An example of this is an iron phosphating solution, which produces a substantially non-crystalline layer of metal phosphates and/or metal oxides on a metal surface, in particular an iron-containing surface. The presence of homo- or co-polymers of vinylpyrrolidone in such a treatment solution improves the corrosion protection attained by the conversion layer. This also applies if the treatment solution, in addition to homo- or co-polymers of vinylpyrrolidone, contains fluoric acids and/or complex fluorides of metals and semi-metals, such as boron, silicon, titanium, zirconium and/or hafnium, as components forming the conversion layer.

A particular aspect of the present invention is that, owing to the anticorrosive action of homo- or co-polymers of vinylpyrrolidone, highly toxic elements, such as chromium or nickel, may be dispensed with in the treatment solution.

Irrespective of how the homo- or co-polymer of vinylpyrrolidone is contacted with the metal surface, it is particularly preferable that a homo- or co-polymer of vinylpyrrolidone of a type which contains caprolactam groups be used. It is possible that, owing to the presence of the caprolactam groups, these homo- or co-polymers of vinylpyrrolidone will exhibit an increased reactivity with metal ions, so that the homo- or co-polymers of vinylpyrrolidone will be bonded particularly firmly to the metal surface by the caprolactam groups or by products of reaction with the metal surface or with constituents of a previously applied conversion layer.

In another aspect, the present invention relates to agents for treating metal surfaces, containing:

(a) 0.02 to 200 g/l phosphoric acid and/or at least one fluoric acid of one or more elements selected from Zr, Ti, Hf and Si or anions thereof, as well as

(b) 0.05 to 200 g/l of a homo- or co-polymer of vinylpyrrolidone.

When phosphoric acid is present, the agent for treating metal surfaces is a phosphating solution. If this does not contain ions of divalent metals, such as zinc and/or manganese, it is a so-called “non-layer-forming” phosphating solution, for example, it may be in the form of an iron phosphating solution. Phosphating solutions containing zinc and/or manganese, which contain, for example, 0.3 to 2 g/l zinc ions and, if desired, in addition to or instead of this about the same concentration of manganese ions, are referred to as so-called “layer-forming” phosphating solutions in the field of conversion treatment. The treatment solution may also contain one or more fluoric acids of one or more elements selected from Zr, Ti, Hf and Si, together with or instead of phosphoric acid. Depending on the adjusted pH of the solution, both phosphoric acid and the above-mentioned fluoric acids are present partly in the form of singly or multiply negatively charged anions. The ratio of acidic anions to undissociated acid depends on the protolysis constant of the respective acid and on the pH actually established. This phenomenon is generally known as the acid-base equilibrium.

To treat the metal surfaces, these agents may be used as such or after dilution with water. In addition to the above-mentioned essential components, the agents contain water as well as, if desired, further active components or auxiliary substances in order to adjust the pH, to increase the anticorrosive action, to improve the applicability and possibly for other purposes.

In the industrial field concerned, involving the corrosion protection treatment of metal surfaces, in particular in the form of a conversion treatment, it is conventional to sell concentrates from which the ready-to-use treatment solutions are prepared at the site of application by dilution with water and, if necessary, adjustment of the pH. The theoretically possible alternative, that of preparing the treatment solutions at the site of application by dissolving the individual components in water within the desired concentration range, is generally felt to be impractical by the users of such solutions. Accordingly, the agent according to the present invention may be in the form of a concentrate containing:

(a) 0.2 to 200 g/l phosphoric acid and/or at least one fluoric acid of one or more elements selected from Zr, Ti, Hf and Si or anions thereof, as well as

(b) 0.5 to 200 g/l of a homo- or co-polymer of vinylpyrrolidone. The ready-to-use solutions which are to be contacted with the metal surfaces may be prepared from this by dilution with water and optional adjustment of the pH. Here, the dilution factor is generally in the range of about 10 to about 200.

In a further aspect of the present invention, the agent is already in the form of a ready-to-use application solution containing:

(a) 0.02 to 20 g/l phosphoric acid and/or at least one fluoric acid of one or more elements selected from Zr, Ti, Hf and Si or anions thereof, as well as

(b) 0.05 to 20 g/l of a homo- or co-polymer of vinylpyrrolidone.

This solution for application may be obtained by diluting the concentrate described above. Depending on the specific composition thereof, concentrates which already contain all the active components may not be sufficiently stable in storage for a long period. In such cases, it is preferable to divide the concentrates into at least two components, each containing selected components of the ready-to-use anticorrosive agent. For example, it may be advisable for one component of the concentrate to contain at least mainly the inorganic constituents of the agent, while at least one other component of the concentrate contains the organic polymers. The two components of the concentrate may have different pH, whereby the stability in storage of the components of the concentrate may be increased. To prepare or replenish the agent in its applied form, the individual components of the concentrate are diluted with water to the extent that the active components are within the desired concentration range. Here, it may be necessary to adjust the pH to within the required range by addition of an acid or of a lye.

Preferred concentration ranges for the active components (a) and (b) in the solution for application, in the case of phosphoric acid or phosphate ions, are 5 to 20 g/l, in particular 8 to 16 g/l phosphate ions, and in the case of the fluoric acids are a quantity such that Zr, Ti, Hf and/or Si, based on these elements, are present in a concentration within the range of between 20 and 1000 mg/l, in particular 50 to 400 mg/l. The concentration of the homo- or co-polymers of vinylpyrrolidone in the solution for application is preferably within the range of 50 to 2000 mg/l, preferably within the range of 80 to 1000 mg/l and in particular within the range of 100 to 800 mg/l.

Suitable homo- or co-polymers of vinylpyrrolidone are, for example, the polymers listed in Table 1 or polymers of the monomers named therein.

TABLE 1
Examples of homo- or co-polymers of vinylpyrrolidone

| | |
|---|---|
| | Trade name and |
| Name | manufacturer |

| | |
|---|---|
| Vinylpyrrolidone, homopolymer | Luviskol ®, BASF/ |
| | ISP |
| Vinylpyrrolidone/Vinyl acetate | Luviskol ®, BASF/ |
| | ISP |
| Vinylpyrrolidone/Vinylcaprolactam | Luvitec ®, BASF |
| Vinylpyrrolidone/Vinylimidazole | Luvitec ®, BASF |
| Vinylpyrrolidone/Vinylimidazolium | Luvitec ®, BASF |
| methyl sulfate | |
| Vinylpyrrolidone/Na methacrylate | Luvitec ®, BASF |
| Vinylpyrrolidone/olefins | ISP ®, Antaron |
| Vinylpyrrolidone/Dimethylaminoethyl | ISP ® |
| methacrylate | |
| Vinylpyrrolidone/Dimethylaminopropyl- | ISP ®, Styleze |
| methacrylamide | |
| Vinylpyrrolidone/Dimethylaminoethyl | ISP ®, Gafquat |
| methacrylate, | |
| ammonium salt | |
| Vinylpyrrolidone/Vinylcaprolactam/ | ISP ® |
| Dimethylaminoethyl | |
| methacrylate | |
| Vinylpyrrolidone/Methacrylamido- | ISP ®, Gafquat |
| propyltrimethyl- | |
| ammonium chloride | |
| Vinylpyrrolidone/Vinylcaprolactam/ | ISP ®, Advantage |
| Dimethylaminoethyl | |
| methacrylate | |
| Vinylpyrrolidone/Styrene | ISP ®, Antara |

In order to increase the corrosion protection, the agents according to the present invention may contain other transition metal ions, such as ions of the elements zinc, manganese, cerium or vanadium, also hydrofluoric acid or free fluorides. The presence of chromium ions or nickel ions may in principle also have advantages. However, for reasons of industrial safety and environmental protection, the addition of chromium ions or nickel ions is preferably avoided. Consequently, in a preferred embodiment of the present invention, the agent is free from nickel and chromium. This means that these metals or compounds thereof are not intentionally added to the agent. The possibility cannot be ruled out, however, that ions of nickel and/or chromium, originating from the material of the tank or from the surfaces to be treated, such as steel alloys, will enter the agent (the treatment solution) in low concentrations. However, in practice, it is anticipated that the concentrations of nickel and/or chromium in the ready-to-use treatment solution will not be more than about 10 ppm.

In the form of the ready-to-use solution for application, the agent according to the present invention has a pH preferably in the range of 1 to 6 and in particular in the range of 2 to 5.5. This means that the fluoric acids of the elements Zr, Ti, Hf or Si, depending on pH and protolysis constants, are partly in the form of the free acids, but partly in the form of the acidic anions thereof. It is therefore irrelevant whether these fluoric acids are used as such or in the form of the salts. Furthermore, acid-soluble compounds of Zr, Ti, Hf or Si, as well as hydrofluoric acid or soluble fluorides may be added separately, as the fluoro anions of the above-mentioned elements may be formed from these. Depending on the method of use, the pH has to be adjusted to the desired range by addition of acid, such as the free fluoric acids of the above-mentioned elements, but even, for example, hydrofluoric acid, sulfuric acid, nitric acid or phosphoric acid or by addition of a base, such as alkali metal carbonate solution, alkali metal hydroxide solution or ammonia.

By reason of the previously-described especially good anticorrosive action of homo- or co-polymers of vinylpyrrolidone which contain caprolactam groups, in a particular embodiment, the agent according to the present invention contains homo- or co-polymers of vinylpyrrolidone containing caprolactam groups.

A further aspect of the present invention is a process for treating metal surfaces, wherein the metal surfaces which, if desired, may already carry an anticorrosive layer, are contacted with the above-mentioned agent in the form of its ready-to-use application solution. The metal surfaces may be selected, for example, from surfaces made of steel, zinc-plated steel (electroplated or hot-dip galvanised), steel coated with zinc alloy, or of aluminum or magnesium. Here, the metals aluminum and magnesium are generally not in pure form, but in the form of alloys with other elements, such as lithium, zinc, copper, silicon, magnesium (in the case of aluminum alloys) or aluminum (in the case of magnesium alloys). The process is envisaged in particular for the treatment of surfaces made of those metals which are used in the construction of vehicles, in the household appliance industry, or in the field of architecture or furnishings.

In this connection, metal surfaces which as yet have no anticorrosive layer may be treated. The treatment process according to the present invention then produces an anticorrosive coating, which at the same time improves the adhesion of an organic coating, such as a lacquer, optionally to be applied subsequently. However, those metal surfaces which already have a previously-formed anticorrosive layer may also be treated by the process according to the present invention. In this case, the anticorrosive action of this previously applied anticorrosive layer is further improved. For example, the process according to the present invention is suitable for the after-treatment of metal surfaces which have an X-ray-amorphous or crystalline coating, such as are produced, for example, by a non-layer-forming or a layer-forming phosphating, for instance, a layer-forming zinc phosphating. The treatment according to the present invention of such pretreated metal surfaces results in the closure of the pores remaining in the initial anticorrosive layer after the pretreatment.

In the treatment process according to the present invention, the metal surfaces may be contacted with the treatment solution, for example, by spraying or dipping. In this case, it is preferable to arrange that the treatment solution be rinsed off with water after a contact time, which may range, for example, from 30 seconds to 5 minutes.

Alternatively, the treatment solution may be contacted with the metal surface in the so-called no-rinse process. Here, the treatment solution is either sprayed onto the metal surface or transferred onto the surface by spreading rollers. After a contact time, which may range, for example, from 2 to 20 seconds, the treatment solution is then dried without further intermediate rinsing. This may take place, for example, in a heated furnace.

For the treatment process according to the present invention, the treatment solution preferably has a pH in the range of 1 to 6. However, narrower pH ranges may be preferred, depending on the substrate and method of application and the contact time.

For example, the pH is preferably adjusted to within the range of 2 to 6 for the treatment of bare metal surfaces; in particular to within the range of 2 to 4 for the treatment of aluminum surfaces and in particular to within the range of 3 to 5 for the treatment of steel, zinc or zinc-plated steel. Already pretreated metal surfaces having, for example, a phosphate layer, are preferably contacted with a treatment solution having a pH in the range of 3.5 to 5. The temperature of the treatment solution in the course of the process according to the present invention may generally be between the freezing point and the boiling point of the treatment solution, temperatures in the region of room temperature or above being preferred for practical reasons. For example, the temperature of the treatment solution may be within the range of 15 to 60° C. and in particular from 20 to 45° C.

The treatment process according to the present invention is one step in an otherwise conventional sequence of process steps in the field concerned. For example, the metal surfaces to be treated are usually cleaned using a conventional cleaning solution prior to the treatment according to the present invention. However, the cleaning step may be omitted if, immediately before the treatment according to the present invention, the metal surfaces to be treated are coated, for example zinc-plated, or are subjected to a conversion treatment, for example, a phosphating. After the treatment step according to the present invention, the metal surfaces are conventionally coated with an organic coating, for instance, a lacquer. This may be a powder coating, for example, or an electrolytically, especially cathodically, precipitable electrophoretic coating.

### EXAMPLES

The treatment process according to the present invention was tested on cold rolled steel (CRS) and on aluminum (alloy AC 120) in comparison with a commercially used process according to the prior art. The individual processing steps are given below.

### Example 1

### CRS

1. Cleaning using an alkaline cleaning agent (Ridoline® 1559, 2%, and Ridosol®) 1270, 0.2% (Henkel KGaA), 5 minutes, 55° C.)

2. Rinsing using deionized water

3. Conversion treatment according to the present invention, during which two concentrates having the composition shown in Table 2 were diluted with water in the weight ratio 1:200. pH: 4, Temperature: 30° C., Immersion time: 150 seconds

4. Drying by means of compressed air without intermediate rinsing

5. Coating using a lead-free electrophoretic coating (Cathogard® 310, BASF)

### Comparison Example 1

The treatment was as described above, except that in Step 3, 250 ppm poly[(5-vinyl-2-hydroxyl)-N-benzyl-N-methylglucamine] was used instead of the vinylpyrrolidone/vinylcaprolactam polymer.

TABLE 2
Composition of the concentrates prior to the dilution in Step 3 (wt. %)

| Inorganic: | | |
|---|---|---|
| Water | 88 | wt. % |
| Hexafluorotitanic acid, 50% | 10 | wt. % |
| Amorphous SiO₂ | 0.5 | wt. % |
| Zr carbonate-hydroxide-oxide 40% | 1.5 | wt. % |
| Organic: | | |
| Water | 95 | wt. % |
| Vinylpyrrolidone/vinylcaprolactam copolymer | 5 | wt. % |

The sample CRS plates which had been treated as described above were subjected to an alternating climate test for 10 rounds, in accordance with Test Specification VDA 621415 conventionally used in the construction of automobiles. In addition, the coating adhesion was determined in a stone impact test in accordance with VW Test specification 3.17.10, likewise conventionally used in the construction of vehicles.

Table 3 shows the values for the creepage of lacquer (half scribe), as well as the grades for the stone impact test (K value: 1=best coating adhesion, 10 worst coating adhesion).

### Example 2

Substrate: Aluminum Alloy AC 120

The test plates were subjected to the following sequence of processing steps.

1. Cleaning using an alkaline cleaning agent (Ridoline® 124, 2%, and Ridoline® 120 WX, 0.1% (Henkel KGaA), 5 minutes, 552° C.)

2. Rinsing using deionized water

3. Rinsing using deionized water

4. Conversion treatment corresponding to Step 3 of Example 1, but with the pH being adjusted to 2.5.

5. Drying by means of compressed air without intermediate rinsing

6. Coating using a lead-free cathodic electrophoretic coating (Cathogard® CG 310, BASF)

### Comparison Example 2

The processing steps were as in Example 2, except that in Step 4, 250 ppm poly[(5-vinyl-2-hydroxyl)-N-benzyl-N-methylglucamine] was used instead of the vinylpyrrolidone/vinylcaprolactam polymer.

The test plates were subjected to a salt spray test accelerated with acetic acid and copper in accordance with Deutsche Norm DIN 50021, with a test period of 10 days. Subsequently creepage of lacquer and coating adhesion were determined as in Example 1. The results are shown in Table 3.

TABLE 3
Creepage of lacquer (half scribe) and coating adhesion (K value)

| Test | Creepage of lacquer (mm) | K value |
|---|---|---|
| Example 1 | 1.7 | 6.5 |
| Comparison 1 | 8.7 | 10 |
| Example 2 | 0.4 | 7 |
| Comparison 2 | 0.5 | 8 |

1. A process for the corrosion protection treatment of a metal surface, characterised in that the metal surface is contacted with a homo- or co-polymer of vinylpyrrolidone.

2. A process according to claim 1 wherein, after a conversion treatment, the metal surface is contacted with a homo- or co-polymer of vinylpyrrolidone.

3. A process according to one of claims 1 and 2 wherein a lacquer containing a homo- or co-polymer of vinylpyrrolidone is applied to the metal surface.

4. A process according to claim 1 wherein the metal surface is contacted with a homo- or co-polymer of vinylpyrrolidone at the same time that it is being subjected to a conversion treatment.

5. A process according to one or more of claims 1 to 4 wherein the homo- or co-polymer of vinylpyrrolidone contains caprolactam groups.

6. An agent for treating metal surfaces characterised in that it contains:
(a) 0.02 to 200 g/l phosphoric acid and/or at least one fluoric acid of one or more elements selected from Zr, Ti, Hf and Si or anions thereof, as well as (b) 0.05 to 200 g/l of a homo- or co-polymer of vinylpyrrolidone.

7. An agent according to claim 6 wherein it is in the form of a concentrate containing:
(a) 0.2 to 200 g/l phosphoric acid and/or at least one fluoric acid of one or more elements selected from Zr, Ti, Hf and Si or anions thereof, as well as (b) 0.5 to 200 g/l of a homo- or co-polymer of vinylpyrrolidone.

8. An agent according to claim 6 wherein it is in the form of a ready-to-use application solution containing:
(a) 0.02 to 20 g/l phosphoric acid and/or at least one fluoric acid of one or more elements selected from Zr, Ti, Hf and Si or anions thereof, as well as
(b) 0.05 to 20 g/l of a homo- or co-polymer of vinylpyrrolidone.

9. An agent according to one of claims 6 to 8 wherein it is free from nickel and chromium.

10. An agent according to one or more of claims 6 to 9 wherein the homo- or co-polymer of vinylpyrrolidone contains caprolactam groups.

11. A process for treating metal surfaces characterised in that the metal surfaces which, if desired, may already carry an anticorrosive layer, are contacted with an agent according to claim 8.
